(19) United States
(12) Patent Application Publication
(10) Pub. No.: US 2003/0167670 A1
(43) Pub. Date: Sep. 11, 2003

(54) Decorative magnet and holder

(76) Inventors: Elizabeth Brooke Smith, Bend, OR (US); Kelly Stewart Ausland, Bend, OR (US)

Correspondence Address: GLENN C. BROWN, PC, 777 NW WALL STREET, SUITE 308, BEND, OR, 97701, US

(21) Appl. No.: 10/094,872

(22) Filed: Mar. 7, 2002

(51) Int. Cl. G09F 7/04; G09F 3/10

(52) U.S. Cl. 40/600; 40/674

(57) ABSTRACT

A generally planar magnet contained in a traditional matchbook cover. The upper top portion of the cover folds over the front surface of the magnet and inserts between the lower portion of the magnet and the lower portion of the cover. The magnet includes a lower portion that is attached to the lower portion of the matchbook cover, and an upper portion that is detachable from the lower portion. The upper portion can include more than one detachable portion that can be individually removed. In other embodiments, the upper portion of the magnet is not detachable. The front surface of the magnet preferably bears one or more images, and is suitable for advertising or for displaying images.

This invention is related to decorative magnets, and in particular to decorative magnets mounted in a matchbook-like cover.

### BACKGROUND OF THE INVENTION

Matchbooks have long been a popular form of advertising, and occupy a special niche in the history of advertising and promotion. While not as widely used for advertising in recent years, matchbooks continue to be popular as mementos of particular events and places, and as promotional tools and novelty items. This invention combines the attributes of the traditional matchbook with another popular advertising and promotional item—the magnet.

The invention is embodied in a generally planar magnet that is contained in a traditional matchbook cover. The upper top portion of the cover folds over the front surface of the magnet and inserts between the lower portion of the magnet and the lower portion of the cover, as with a traditional matchbook cover. In preferred embodiments, the magnet includes a lower portion that is attached to the lower portion of the matchbook cover, and an upper portion that is detachable from the lower portion. In some embodiments, the upper portion includes more than one detachable portion that can be individually removed and used apart from the assembly. The invention is also embodied in a magnet wherein the upper part is not detachable from the lower portion. The front surface of the magnet preferably bears one or more images, and is suitable for advertising or novelty images. These and other features of the invention will be described in greater detail in conjunction with the drawings.

### BRIEF DESCRIPTION OF THE DRAWINGS

FIG. 1 is a perspective view of a magnet and cover according to the present invention.

FIG. 2 is a side elevational view of the magnet and cover shown in FIG. 1.

FIG. 3 is a top plan view of a magnet and holder shown in FIG. 1, and in which the cover has been opened to display the magnet held inside.

FIGS. 4-6 are top plan views of the magnets of various embodiments and which have differing numbers of detachable portions.

FIGS. 7-9 are top plan views of magnets of alternate embodiments of the invention and showing different illustrative images on the front surface of the magnets.

FIG. 10 is a top plan view of a magnet portion of the invention in which the upper portion is horizontally segmented.

### DETAILED DESCRIPTION OF THE INVENTION

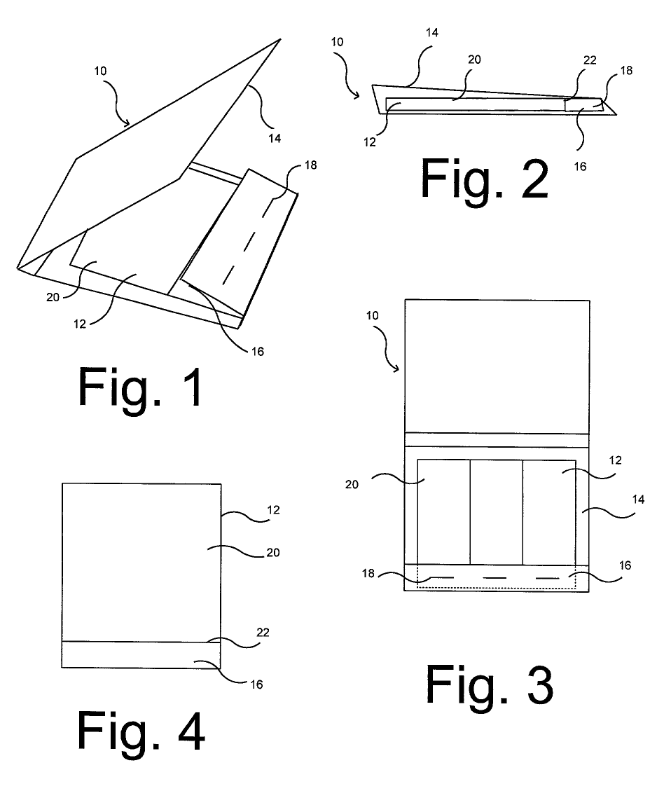

Referring to FIGS. 1-3, a magnet and cover assembly according to a preferred embodiment of the invention is shown generally at 10. The assembly includes a planar magnet 12, and a cover 14 encircling the magnet 12. The magnet is secured by a lower portion 16 to the lower portion of the cover 14 by staples 18. In other embodiments, the magnet is attached to the cover by an adhesive, or by any other suitable means. Referring to FIG. 3, the front upper portion of the cover is operable to expose the magnet 12 and the images formed thereon, and to permit the removal of a portion of the magnet as described below.

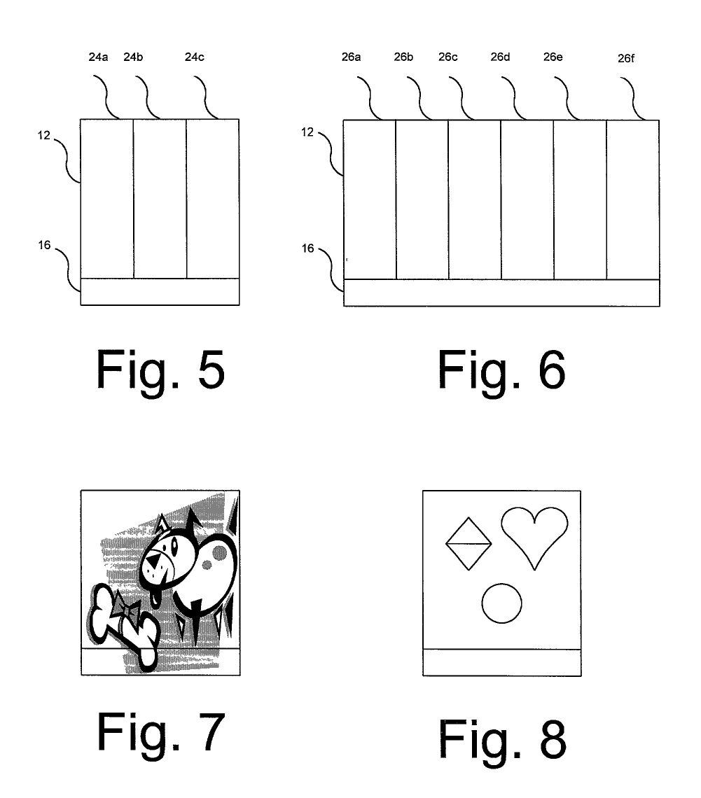

In a preferred embodiment, the magnet 12 includes an upper portion 20 that is detachable from the lower portion 16, permitting the upper portion 20 to be removed and displayed separately on a metal surface such as a refrigerator. Alternatively, the entire magnet and cover assembly can also be magnetically attached to a metallic surface without removing any portion of the magnet 12. Referring to FIG. 4, in the embodiment shown the upper portion 20 is connected to the lower portion 16 by a scored line 22 or a perforation in the magnet that can be broken to separate the upper portion. Referring to FIGS. 5 and 6, the invention is also embodied in magnets that include multiple detachable portions 24a-c (FIG. 5), or 26a-f (FIG. 6). In various embodiments, the segments can be oriented vertically, horizontally or diagonally. In those embodiments, the adjacent segments are separated from the lower portion 16, and each other, by scored lines or perforations.

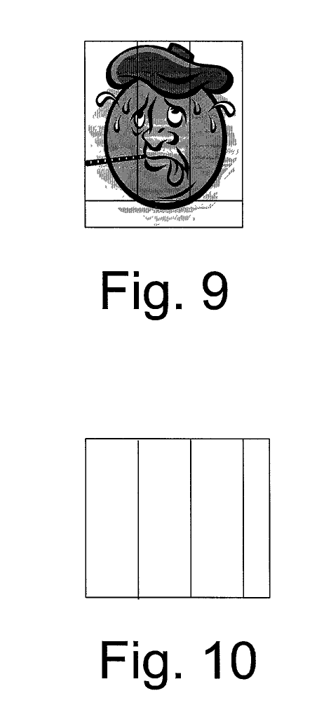

Referring to FIGS. 7-9, the front surfaces of the magnet 12, or individual segments of the magnet, bear advertising, promotional images or text, or collectable images. In addition to a single image, each segment can also bear a separate, self-contained image. The images can include trademarks or logos, humorous images, decorative images, renderings of places or people, or any other image or information that would be of interest to a purchaser. In this way, the traditional use of matchbooks for advertising can be greatly enhanced by the present invention. For example, the name and contact information for a business or person can be placed on each detachable segment of the upper portion 20, and can be removed from the assembly and given to another. Images related to a certain theme, hobby or interest can be displayed on the front surface of the magnet. In another embodiment, rather than the upper portion 20 being separated into vertical, horizontal or diagonal segments; removable shapes can be partially die-cut into the magnet. The applications for the invention are nearly limitless. The invention can be used in each of the traditional ways that matchbooks have been used in the past, while the substitution of a flat magnet for matches inside provides an entirely new medium of novelty and promotional items, and for advertising.

Those of skill in the art will recognize that the invention as described can be modified in detail and configuration without departing from the scope of the following claims.

What is claimed is:

1. A decorative magnet and holder comprising:
a magnet having a base portion and at least one portion that is detachable from the base portion; and,
a holder surrounding the magnet and having a portion that is operable to expose the at least one detachable portion of the magnet.

2. A decorative magnet and holder according to claim 1 in which the at least one detachable portion of the magnet is connected to the base portion of the magnet by a perforation.

3. A decorative magnet and holder according to claim 1 in which the at least one detachable portion is connected to a base portion of the magnet by a scored portion.

4. A decorative magnet and holder according to claim 1 wherein the at least one detachable portion comprises a plurality of detachable portions.

5. A decorative magnet and holder according to claim 4 wherein the at least one detachable portion includes a plurality of portions connected to the base and to one another.

6. A decorative magnet and holder according to claim 1 wherein the at least one detachable portion includes a major surface having an image formed thereon.

7. A decorative magnet and holder according to claim 1 wherein the at least one detachable portion includes a die-cut shape defined thereon.

8. A decorative magnet and holder according to claim 1 wherein the holder comprises a simulated matchbook cover.

9. A decorative magnet and holder according to claim 1 wherein the holder includes a surface having an image formed thereon.

10. A decorative magnet and holder according to claim 1 wherein the magnet and holder are magnetically adherable to an underlying surface to display an image formed on the holder.

11. A decorative magnet and holder according to claim 8 wherein the simulated matchbook cover includes a simulated striker strip formed thereon.

12. A decorative magnet and holder according to claim 11 wherein the simulated matchbook cover includes an image formed on the simulated striker strip.

13. A decorative magnet and holder according to claim 1 wherein the at least one detachable portion comprises a plurality of detachable portions.

14. A decorative magnet and holder according to claim 1 wherein the at least one detachable portion is oriented vertically relative to the base of the holder.

15. A decorative magnet and holder according to claim 13 wherein the at least one detachable portion is oriented horizontally relative to the base of the holder.

16. A decorative magnet and holder according to claim 13 wherein the at least one detachable portion is oriented at an angle relative to the base of the holder.

17. A decorative magnet and holder assembly comprising:
a generally planar magnet having a base portion and a plurality of detachable portions connected to the base portion;
a simulated matchbook cover including a rear portion, an operable front cover connected to the rear portion, and a lower portion engageable with the front cover; and,
the magnet attached to the lower portion of the holder.

18. A decorative magnet and holder assembly comprising:
a generally planar magnet having a base portion and an upper portion;
a simulated matchbook cover including a rear portion, an operable front cover connected to the rear portion, and a lower portion engageable with the front cover; and,
the magnet attached to the lower portion of the holder.
